(19) United States
(12) Patent Application Publication
(10) Pub. No.: US 2023/0005382 A1
(43) Pub. Date: Jan. 5, 2023

(54) METHOD, DEVICE, AND SYSTEM FOR RECOMMENDING SOLUTION CONTENT MAXIMIZING AN EDUCATIONAL EFFECT FOR USERS

(71) Applicant: RIIID INC., Seoul (KR)

(72) Inventor: Hyun Bin LOH, Seoul (KR)

(73) Assignee: RIIID INC., Seoul (KR)

(21) Appl. No.: 17/854,621

(22) Filed: Jun. 30, 2022

(30) Foreign Application Priority Data
Jul. 1, 2021 (KR) 10-2021-0086401

(51) Int. Cl. G09B 5/12; G06F 16/957

(52) U.S. Cl. CPC G09B 5/12; G06F 16/9577

(57) ABSTRACT

According to an embodiment of the present invention, a method of recommending educational content includes acquiring search information of a user, extracting searched question information based on the search information, acquiring a solution content set related to the question information, the solution content set including first solution information and second solution information, calculating learning ability information of the user based on the search information, calculating an index related to an expected educational effect based on the learning ability information and the solution content set, selecting target solution content from the solution content set based on the index, and transmitting the target solution content.

### CROSS-REFERENCE TO RELATED APPLICATION

This application claims priority to and the benefit of Korean Patent Application No. 2021-0086401, filed on Jul. 1, 2021, the disclosure of which is incorporated herein by reference in its entirety.

### BACKGROUND

### 1. Field of the Invention

The present application relates to a method of recommending educational content, a device for recommending educational content, and a system for recommending educational content. More particularly, the present application relates to a method of recommending educational content, a device for recommending educational content, and a system for recommending educational content for quantifying learning ability information of a user.

### 2. Discussion of Related Art

With the development of artificial intelligence technology, the field of education technology which diagnoses learning ability of users and recommending educational content based on the diagnosis result is attracting attention. In particular, in consideration of the users' learning abilities, there is a demand for a technology which provides optimal solution content or webpage to users.

However, the conventional technologies are aimed at providing only solutions corresponding to questions or selecting only high-reliability webpage based on users' search information, but have limitations in providing the best educational content in consideration of the users' learning ability.

Therefore, by quantifying learning ability information of a user and appropriately recommending an optimal solution or educational content related to a webpage to a user based on the learning ability information of the user, development of a method and device for recommending educational content capable of maximizing an educational effect of users is required.

### SUMMARY OF THE INVENTION

The present invention provides a method of recommending educational content, a device for recommending educational content, and a system for recommending educational content for quantifying learning ability information of a user.

The present invention provides a method of recommending educational content, a device for recommending educational content, and a system for recommending educational content for providing a target webpage based on learning ability information of a user.

The present invention provides a method of recommending educational content, a device for recommending educational content, and a system for recommending educational content for providing target solution content based on learning ability information of a user.

Objects that are to be solved by the present invention are not limited to the above-described objects, and objects that are not described will be clearly understood by those skilled in the art to which the present invention pertains from the present specification and the accompanying drawings.

According to an embodiment of the present invention, a method of recommending educational content may include: acquiring search information of a user; extracting searched question information based on the search information; acquiring a solution content set related to the question information, the solution content set including first solution information and second solution information; calculating learning ability information of the user based on the search information, calculating an index related to an expected educational effect based on the learning ability information and the solution content set; selecting target solution content from the solution content set based on the index; and transmitting the target solution content.

According to an embodiment of the present application, a device for recommending educational content by receiving search information of a user from an external user terminal includes: a transceiver configured to communicate with the user terminal; and a controller configured to acquire the search information of the user through the transceiver and select target solution content based on the search information, in which the controller may be configured to acquire the search information of the user, extract searched question information based on the search information, acquire a solution content set related to the question information, the solution content set including first solution information and second solution information, calculate learning ability information of the user based on the search information, calculate an index related to an expected educational effect based on the learning ability information and the solution content set, select target solution content from the solution content set based on the index, and transmit the target solution content.

According to an embodiment of the present invention, a method of recommending educational content may include: acquiring search information of a user; acquiring a candidate webpage set based on the search information, the candidate webpage set including a first webpage and a second webpage; calculating learning ability information of the user based on the search information; calculating a first index related to an expected educational effect when the first webpage is provided to the user based on the learning ability information and first content information included in the first webpage; calculating a second index related to an expected educational effect when the second webpage is provided to the user based on the learning ability information and second content information included in the second webpage; selecting a target webpage based on the first index and the second index; and transmitting the target webpage.

According to an embodiment of the present application, a device for selecting a target webpage to be provided to a user by receiving search information of the user from a user terminal may include a transceiver configured to communicate with the user terminal; and a controller configured to acquire the search information of the user through the transceiver and select the target webpage based on the search information, in which the controller may be configured to acquire the search information of the user, acquire a candidate webpage set based on the search information, the candidate webpage set including a first webpage and a second webpage, calculate learning ability information of the user based on the search information, calculate a first index related to an expected educational effect when the first webpage is provided to the user based on the learning ability information and first content information included in the first webpage, calculate a second index related to an expected educational effect when the second webpage is provided to the user based on the learning ability information and second content information included in the second webpage, and select a target webpage based on the first index and the second index, and transmit the target webpage.

According to an embodiment of the present application, a method of evaluation learning ability may include: acquiring search information of a target user; acquiring learning set information based on the search information; acquiring a search database of a plurality of users based on the leaning set information, the search database including user identification information and a reference value allocated according to whether the user searches for a question included in the learning set information; allocating a feature value according to whether to search for at least one question included in the learning set information based on the search information; generating a first matrix based on the reference value of the search database and the feature value related to the target user; transforming the first matrix into a second matrix based on similarity of the reference value and the feature value; and calculating a learning ability score of the target user based on the second matrix.

According to an embodiment of the present application, a device for quantifying learning ability of a target user by receiving search information of the target user from an external user terminal may include: a transceiver configured to communicate with the user terminal; and a controller configured to acquire the search information of the target user through the transceiver and quantify the learning ability of the target user based on the search information, in which the controller may be configured to acquire the search information of the target user, acquire learning set information based on the search information, acquire a search database of a plurality of users based on the leaning set information, the search database including user identification information and a reference value allocated according to whether the user searches for a question included in the learning set information, allocate a feature value according to whether to search for at least one question included in the learning set information based on the search information, generate a first matrix based on the reference value of the search database and the feature value related to the target user, transform the first matrix into a second matrix based on similarity of the reference value and the feature value, and calculate a learning ability score of the target user based on the second matrix.

Technical solutions of the present invention are not limited to the above-described solutions, and solutions that are not described will be clearly understood by those skilled in the art to which the present invention pertains from the present specification and the accompanying drawings.

### BRIEF DESCRIPTION OF THE DRAWINGS

FIG. 1 is a schematic diagram of a system for recommending educational content according to an embodiment of the present application.

FIG. 2 is a diagram illustrating an operation of a device (1000) for recommending educational content according to the first embodiment of the present application.

FIG. 3 is a flowchart of a method of recommending educational content according to a first embodiment of the present application.

FIG. 4 is an exemplary diagram illustrating an aspect in which the device (1000) for recommending educational content selects target solution content according to the first embodiment of the present application.

FIG. 5 is a diagram illustrating an operation of a device (1000) for recommending educational content according to a second embodiment of the present application.

FIG. 6 is a flowchart of a method of recommending educational content according to the second embodiment of the present application.

FIG. 7 is an exemplary diagram illustrating an aspect in which the device (1000) for recommending educational content selects a target webpage according to the second embodiment of the present application.

FIG. 8 is a flowchart illustrating a method of calculating learning ability information of a user according to an embodiment of the present application.

FIG. 9 is a detailed flowchart of an operation (S3400) of allocating a feature value based on search information according to an embodiment of the present application.

FIG. 10 is a diagram illustrating an aspect of allocating a feature value based on the search information according to the embodiment of the present application.

FIG. 11 is a diagram illustrating an aspect of a first matrix and a second matrix generated according to an embodiment of the present application.

FIG. 12 is a detailed flowchart of a method of calculating a learning ability score of a target user according to an embodiment of the present application.

FIG. 13 is a diagram illustrating an aspect of training a neural network model to acquire comparison information according to an embodiment of the present application.

FIG. 14 is a diagram illustrating an aspect of acquiring comparison information and a learning ability score of a target user through the neural network model trained according to the embodiment of the present application.

### DETAILED DESCRIPTION OF EXEMPLARY EMBODIMENTS

Objects, features, and advantages of the present application will become more obvious from the following detailed description provided in relation to the accompanying drawings. However, the present application may be variously modified and have several exemplary embodiments. Hereinafter, specific exemplary embodiments of the present invention will be illustrated in the accompanying drawings and described in detail.

In principle, the same reference numerals denote the same constituent elements throughout the specification. Further, elements having the same function within the scope of the same idea illustrated in the drawings of each embodiment will be described using the same reference numerals, and overlapping descriptions thereof will be omitted.

When it is determined that a detailed description for the known functions or configurations related to the present application may obscure the gist of the present disclosure, detailed descriptions thereof will be omitted. In addition, numbers (for example, first, second, etc.) used in the description process of the present specification are only identification symbols for distinguishing one component from other components.

In addition, suffixes “module” and “unit” for components used in the following embodiments are used only in order to easily make the disclosure. Therefore, these terms do not have meanings or roles that distinguish from each other in themselves.

In the following embodiments, singular forms include plural forms unless interpreted otherwise in context.

In the following embodiments, the terms “include” or “have” means that a feature or element described in the specification is present, and therefore, do not preclude, in advance, the possibility that one or more other features or components may be added.

Sizes of components may be exaggerated or reduced in the accompanying drawings for convenience of explanation. For example, the size and thickness of each component illustrated in the drawings are arbitrarily indicated for convenience of description, and the present invention is not necessarily limited to those illustrated.

In a case where certain embodiments can be otherwise implemented, the order of specific processes may be performed differently from the order in which the processes are described. For example, two processes described in succession may be performed substantially simultaneously or may be performed in an order opposite to the order described.

In the following embodiments, when components are connected, it includes not only a case where components are directly connected but also a case where components are indirectly connected via certain component interposed between the components.

For example, in the present specification, when components and the like are electrically connected, it includes not only a case where components are directly electrically connected, but also a case where components are indirectly electrically connected via certain component interposed between the components.

According to an embodiment of the present invention, a method of recommending educational content may include: acquiring search information of a user, extracting searched question information based on the search information; acquiring a solution content set related to the question information, the solution content set including first solution information and second solution information; calculating learning ability information of the user based on the search information, calculating an index related to an expected educational effect based on the learning ability information and the solution content set; selecting target solution content from the solution content set based on the index; and transmitting the target solution content.

According to an embodiment of the present application, the search information may include log data including searched time data and reading time data of a search result.

According to an embodiment of the present application, the calculating of the learning ability information may include: acquiring learning set information based on the log data and the question information; and calculating the learning ability information according to whether to search for questions included in the learning set information.

According to an embodiment of the present application, the acquiring of the learning set information may include: acquiring question information on which a search is performed for a first period based on time data of the log data and the question information; and acquiring the learning set information based on the question information.

According to an embodiment of the present invention, the calculating of the index may include acquiring a first index related to an expected educational effect when the first solution information is provided to the user based on the learning ability information and the first solution information, and acquiring a second index related to an expected educational effect when the second solution information is provided to the user based on the learning ability information and the second solution information.

According to an embodiment of the present invention, the selecting of the target solution content may include comparing the first index and the second index to determine that the solution information calculated with a greater value is the target solution content.

According to an embodiment of the present application, a computer-readable recording medium, on which a program for executing the method of recommending educational content is recorded, may be provided.

According to an embodiment of the present application, a device for recommending educational content by receiving search information of a user from an external user terminal may include: a transceiver configured to communicate with the user terminal; and a controller configured to acquire the search information of the user through the transceiver and select target solution content based on the search information, in which the controller may be configured to acquire the search information of the user, extract searched question information based on the search information, acquire a solution content set related to the question information, the solution content set including first solution information and second solution information, calculate learning ability information of the user based on the search information, calculate an index related to an expected educational effect based on the learning ability information and the solution content set, select target solution content from the solution content set based on the index, and transmit the target solution content.

According to an embodiment of the present application, the search information may include log data including searched time data and reading time data of a search result.

According to an embodiment of the present application, the controller may be configured to acquire learning set information based on the log data and the question information, and calculate the learning ability information according to whether to search for questions included in the learning set information.

According to an embodiment of the present application, the controller may be configured to acquire question information on which a search is performed for a first period based on the time data of the log data and the question information, and acquire the learning set information based on the question information.

According to an embodiment of the present application, the controller may be configured to acquire a first index related to an expected educational effect when the first solution information is provided to the user based on the learning ability information and the first solution information, and acquire a second index related to an expected educational effect when the second solution information is provided to the user based on the learning ability information and the second solution information.

According to an embodiment of the present application, the controller may be configured to compare the first index and the second index to determine that the solution information calculated with a greater value is the target solution content.

According to an embodiment of the present invention, a method of recommending educational content may include acquiring search information of a user; acquiring a candidate webpage set based on the search information, the candidate webpage set including a first webpage and a second webpage; calculating knowledge level information of the user based on the search information; calculating a first index related to an expected educational effect when the first webpage is provided to the user based on the knowledge level information and first content information included in the first webpage; calculating a second index related to an expected educational effect when the second webpage is provided to the user based on the knowledge level information and second content information included in the second webpage; selecting a target webpage based on the first index and the second index; and transmitting the target webpage.

According to an embodiment of the present application, the search information may include log data including searched time data and reading time data of the search result, and question identification information indicating the searched question.

According to an embodiment of the present application, the calculating of the knowledge level information may include: acquiring learning set information based on the log data and the question information; and calculating the knowledge level information based on whether to search for questions included in the learning set information.

According to an embodiment of the present application, the acquiring of the learning set information may include: acquiring question information on which a search is performed for a first period based on time data of the log data and the question information; and acquiring the learning set information based on the question information.

According to an embodiment of the present application, the acquiring of the candidate webpage set includes: extracting a keyword from the search information; and acquiring a candidate webpage set including content related to the extracted keyword.

According to an embodiment of the present invention, the selecting of the target webpage may include comparing the first index and the second index to determine that the webpage calculated with a greater value is the target webpage.

According to an embodiment of the present application, a computer-readable recording medium, on which a program for executing the method of recommending educational content is recorded, may be provided.

According to an embodiment of the present application, a device for selecting a target webpage to be provided to a user by receiving search information of the user from a user terminal may include a transceiver configured to communicate with the user terminal; and a controller configured to acquire the search information of the user through the transceiver and select the target webpage based on the search information, in which the controller may be configured to acquire the search information of the user, acquire a candidate webpage set based on the search information, the candidate webpage set including a first webpage and a second webpage, calculate knowledge level information of the user based on the search information, calculate a first index related to an expected educational effect when the first webpage is provided to the user based on the knowledge level information and first content information included in the first webpage, calculate a second index related to an expected educational effect when the second webpage is provided to the user based on the knowledge level information and second content information included in the second webpage, and select a target webpage based on the first index and the second index, and transmit the target webpage.

According to an embodiment of the present application, the search information may include log data including searched time data and reading time data of the search result, and question identification information indicating the searched question.

According to an embodiment of the present application, the controller may be configured to acquire learning set information based on the log data and the question information, and calculate the knowledge level information according to whether to search for questions included in the learning set information.

According to an embodiment of the present application, the controller may be configured to acquire question information on which a search is performed for a first period based on the time data of the log data and the question identification information, and acquire the learning set information based on the question identification information.

According to an embodiment of the present application, the controller may be configured to extract a keyword from the search information and acquire a candidate webpage set including content related to the extracted keyword.

According to an embodiment of the present application, the controller may be configured to compare the first index and the second index to determine that the webpage calculated with a greater value is the target webpage.

According to an embodiment of the present application, a method of evaluation learning ability may include: acquiring search information of a target user; acquiring learning set information based on the search information; acquiring a search database of a plurality of users based on the leaning set information, the search database including user identification information and a reference value allocated according to whether the user searches for a question included in the learning set information; allocating a feature value according to whether to search for at least one question included in the learning set information based on the search information; generating a first matrix based on the reference value of the search database and the feature value related to the target user; transforming the first matrix into a second matrix based on similarity of the reference value and the feature value; and calculating a learning ability score of the target user based on the second matrix.

According to an embodiment of the present application, the allocating of the feature value may include: allocating a first value to a first question group of the learning set information searched by the target user; and allocating a second value different from the first value to the second question group of the learning set information not searched by the target user.

According to an embodiment of the present application, the transforming into the second matrix may include acquiring the second matrix by performing a block compress on the first matrix.

According to an embodiment of the present application, the calculating of the learning ability score of the target user may include: acquiring comparison information indicating relative position of the target user with respect to the plurality of users based on the second matrix; and calculating the learning ability score of the target user based on the comparison information.

According to an embodiment of the present application, a computer-readable recording medium, on which a program for executing the learning ability evaluation method is recorded, may be provided.

According to an embodiment of the present application, a device for quantifying learning ability of a target user by receiving search information of the target user from an external user terminal may include: a transceiver configured to communicate with the user terminal; and a controller configured to acquire the search information of the target user through the transceiver and quantify the learning ability of the target user based on the search information, in which the controller may be configured to acquire the search information of the target user, acquire learning set information based on the search information, acquire a search database of a plurality of users based on the leaning set information, the search database including user identification information and a reference value allocated according to whether the user searches for a question included in the learning set information, allocate a feature value according to whether to search for at least one question included in the learning set information based on the search information, generate a first matrix based on the reference value of the search database and the feature value related to the target user, transform the first matrix into a second matrix based on similarity of the reference value and the feature value, and calculate a learning ability score of the target user based on the second matrix.

According to an embodiment of the present application, the controller may be configured to allocate the first value as the feature value to the first question group of the learning set information searched by the target user, and allocate the second value different from the first value as the feature value to the second question group of the learning set information not searched by the target user.

According to an embodiment of the present application, the controller may be configured to acquire the second matrix by performing the block compress on the first matrix.

According to an embodiment of the present application, the controller may be configured to acquire the comparison information indicating the relative position of the target user with respect to the plurality of users based on the second matrix, and calculate the learning ability score of the target user based on the comparison information.

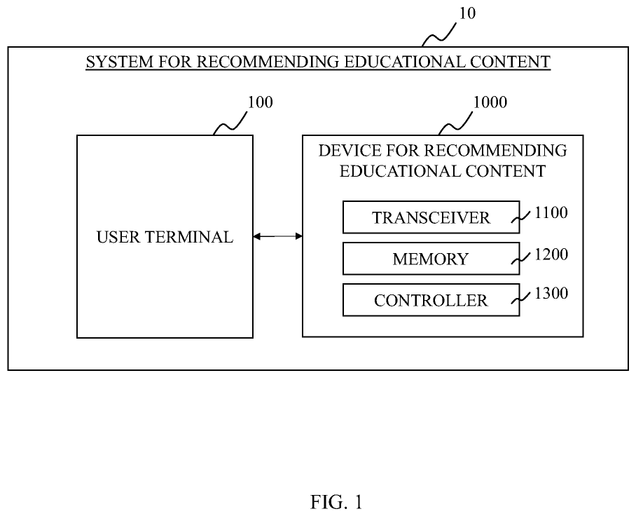

Hereinafter, a method of recommending educational content, a device for recommending educational content, and a system for recommending educational content according to embodiments of the present application will be described with reference to FIGS. 1 to 14.

FIG. 1 is a schematic diagram of a system for recommending educational content according to an embodiment of the present application.

A system 10 for recommending educational content according to the embodiment of the present application may include a user terminal 100 and a device 1000 for recommending educational content.

The user terminal 100 may acquire a question database from the device 1000 for recommending educational content or any external device. For example, the user terminal 100 may receive some questions included in the question database and display the received questions to a user. Then, the user may input a response to the presented question into the user terminal 100.

The user terminal 100 may acquire training data based on the response of the user and transmit the training data of the user to the device 1000 for recommending educational content. Here, the training data may refer to encompassing the question identification information solved by the user, the response information of the user thereto, and/or correct or incorrect answer information, and the like. Meanwhile, the user terminal 100 may transmit the identification information of the user to the device 1000 for recommending educational content.

In addition, the user terminal 100 may acquire the search information of the user and transmit the search information of the user to the device 1000 for recommending educational content. Here, the search information may refer to encompassing log data related to a search of a user, search-related question identification information, a search query, and any type of information derived from the search query. The log data may include time data on which a search is performed, reading time data of a search result, and the like. The question identification information may refer to encompassing any information indicating a question searched by a user.

Meanwhile, the user terminal 100 may receive the recommended content calculated from the device 1000 for recommending educational content. In addition, the user terminal 100 may display the received recommended content to the user.

Here, the recommended content may refer to content related to any education acquired based on search information, such as a webpage related to education, a solution to a question related to a search, and a recommendation question.

The device 1000 for recommending educational content according to the embodiment of the present application may include a transceiver 1100, a memory 1200, and a controller 1300.

The transceiver 1100 may communicate with any external device including the user terminal 100. For example, the device 1000 for recommending educational content may receive the training data of the user, user identification information, and/or search information from the user terminal 100 through the transceiver 1100 or transmit the recommended content to the user terminal 100.

The device 1000 for recommending educational content may transmit and receive various types of data by accessing the network through the transceiver 1100. The transceiver 1100 may largely include a wired type and a wireless type. Since the wired type and the wireless type have their respective strengths and weaknesses, in some cases, the wired type and the wireless type may be simultaneously provided in the device 1000 for recommending educational content. Here, in the case of the wireless type, a wireless local area network (WLAN)-based communication method such as Wi-Fi may be mainly used. Alternatively, in the case of the wireless type, cellular communication, for example, long term evolution (LTE), 5G-based communication method may be used. However, the wireless communication protocol is not limited to the above-described example, and any suitable wireless type communication method may be used.

In the case of the wired type, local area network (LAN) or universal serial bus (USB) communication is a representative example, and other methods are also possible.

The memory 1200 may store various types of information. Various types of data may be temporarily or semi-permanently stored in the memory 1200. An example of the memory 1200 may include a hard disk drive (HDD), a solid state drive (SSD), a flash memory, a read-only memory (ROM), a random access memory (RAM), or the like. The memory 1200 may be provided in a form embedded in the device 1000 for recommending educational content or in a detachable form. Various types of data necessary for operating the device 1000 for recommending educational content as well as an operating program (OS) for driving the device 1000 for recommending educational content or a program for operating each configuration of the device 1000 for recommending educational content may be stored in the memory 1200.

The controller 1300 may control the overall operation of the device 1000 for recommending educational content. For example, the controller 1300 may control the overall operation of the device 1000 for recommending educational content, such as calculating learning ability information based on the search information of the user to be described below, quantifying an expected educational effect of a user when learning educational content, or determining target solution content or a target webpage. Specifically, the controller 1300 may load and execute a program for the overall operation of the device 1000 for recommending educational content from the memory 1200. The controller 1300 may be implemented as an application processor (AP), a central processing unit (CPU), or a device similar thereto according to hardware, software, or a combination thereof. In this case, in a hardware manner, the controller may be provided in an electronic circuit form processing an electrical signal to perform a control function, and in a software manner, the controller may be provided in a program or code form driving hardware-type circuits.

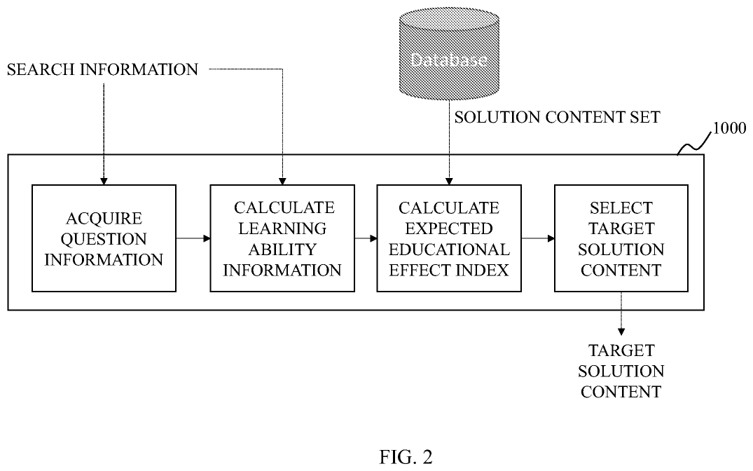

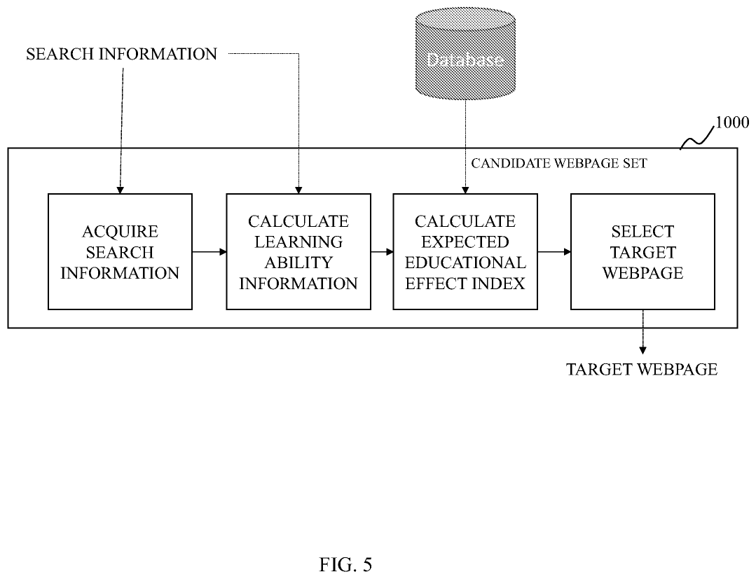

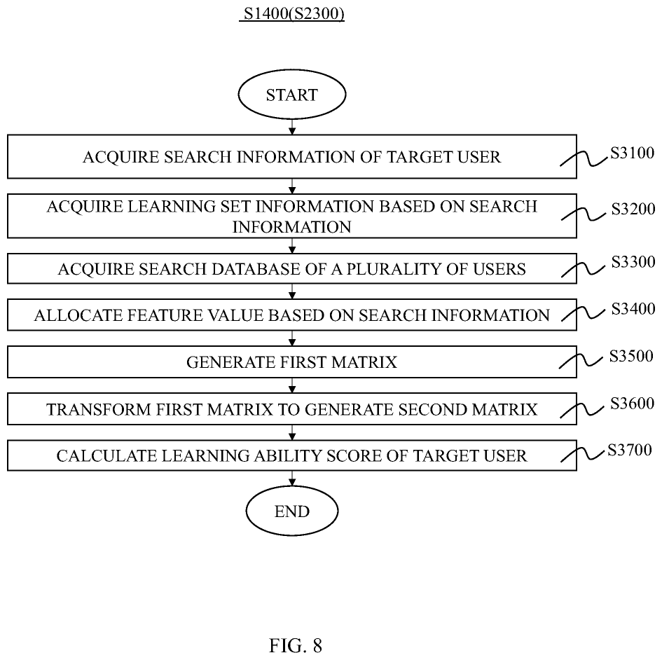

Hereinafter, the operation of the device 1000 for recommending educational content according to embodiments of the present application will be described in detail with reference to FIGS. 2 to 14. Specifically, an operation of the device 1000 for recommending educational content for selecting the target solution content based on the search information of the user according to a first embodiment of the present application is described with reference to FIGS. 2 to 4. An operation of the device 1000 for recommending educational content for selecting a target webpage based on search information of a user according to a second embodiment of the present application will be described with reference to FIGS. 5 to 7. An operation of the device 1000 for recommending educational content that calculates learning ability information of a user based on the search information of the user will be described with reference to FIGS. 8 to 14.

The device 1000 for recommending educational content according to the first embodiment of the present application may perform an operation of recommending solution content based on the search information of the user.

According to the related art, when a user captures a question as an image or inputs contents of the question, solution information corresponding to the input is acquired and provided to the user. However, a plurality of solutions may exist for a specific question. Specifically, various methods of solving the same question may exist, and the learning effect of the user may vary according to the solution. However, the related art provides only one solution corresponding to one question. Therefore, research on a technique for acquiring a plurality of solution content sets related to the searched question and selecting solution content that may maximize the educational effect for the user is required.

The device 1000 for recommending educational content according to the first embodiment of the present application calculates the learning ability information of the user based on the search information of the user and selects the target solution content based on the learning ability information of the user, and thus solution content optimized for a user may be provided to the user.

Hereinafter, with reference to FIG. 2, the operation of the device 1000 for recommending educational content according to the first embodiment of the present application for achieving the above-described object and effect will be described in detail. FIG. 2 is a diagram illustrating an operation of the device 1000 for recommending educational content according to the first embodiment of the present application.

The device 1000 for recommending educational content according to the embodiment of the present application may acquire search information of a user. Here, as described above, the search information may include the log data related to the search of the user, the search-related question identification information, the search query, and any type of information derived from the search query. In this case, the acquired search information may be used to calculate the learning ability information of the user.

Although not illustrated in FIG. 2, the device 1000 for recommending educational content according to the embodiment of the present application may acquire response information and/or correct or incorrect answer information for a question related to a question solution history of a user.

The device 1000 for recommending educational content according to the embodiment of the present application may acquire question information indicating a question retrieved by a user. Specifically, the device 1000 for recommending educational content may acquire the question information based on the search information of the user. For example, the device 1000 for recommending educational content may acquire the question information based on question identification information of search information. Here, the question information (or question identification information) may be used to acquire a solution content set from a database as will be described below.

The device 1000 for recommending educational content according to the embodiment of the present application may perform an operation of evaluating the learning ability of the user or quantifying the learning ability. Specifically, the device 1000 for recommending educational content may calculate the learning ability information of the user by quantifying the learning ability of the user based on the search information of the user. Herein, the learning ability may refer to ability of a user related to learning or a knowledge level that can be diagnosed using any method such as a current score, a predicted score, reasoning ability, logical power, concentration, potential ability, and a knowledge level for various tests of a user. In addition, the learning ability information may include any type of information that quantifies or may quantify the above-described learning ability.

The device 1000 for recommending educational content according to the embodiment of the present application may generate a matrix by allocating feature values to questions included in the question set based on the search information of the user and calculate the learning ability information of the user based on the generated matrix. The operation of calculating the learning ability information of the user will be described in detail below with reference to FIGS. 8 to 14.

The device 1000 for recommending educational content according to the embodiment of the present application may acquire a solution content set from a database. Specifically, the device 1000 for recommending educational content may acquire the solution content set related to question information from the database based on the question information (or question identification information). For example, in a case where the user searches for a solution related to a first question, the device 1000 for recommending educational content may be implemented to acquire a solution content set including at least one solution content related to the first question from a database.

The device 1000 for recommending educational content according to the embodiment of the present application may estimate or quantify an expected educational effect when each piece of solution content included in the solution content set is provided to the user. Specifically, the device 1000 for recommending educational content may estimate or quantify the expected educational effect when each piece of solution content included in the solution content set is provided to the user based on learning ability information of a user. For example, the device 1000 for recommending educational content may calculate a first index related to the expected educational effect when first solution content included in the solution content set is provided to the user based on the learning ability information of the user. In addition, the device 1000 for recommending educational content may calculate a second index related to the expected educational effect when second solution content included in the solution content set is provided to the user based on the learning ability information of the user.

The device 1000 for recommending educational content according to the embodiment of the present application may select solution content having the greatest educational effect predicted from among the solution content set as target solution content. For example, when the expected educational effect when the first solution content is provided to the user is calculated as the first index, and the expected educational effect when the second solution content is provided to the user is calculated as the second index, the device 1000 for recommending educational content may be implemented to select the target solution content by comparing the first index and the second index. For example, when the first index is calculated to be greater than the second index, the device 1000 for recommending educational content may be implemented to select the first solution content as the target solution content.

The device 1000 for recommending educational content according to the embodiment of the present application may transmit the selected target solution content to the user terminal 100. Specifically, the device 1000 for recommending educational content may transmit the selected target solution content to the user terminal 100 through the transceiver 1100.

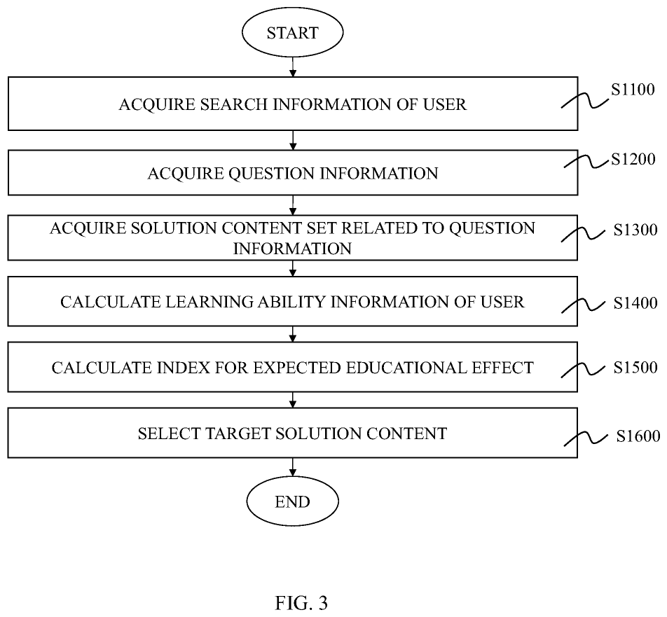

FIG. 3 is a flowchart of a method for recommending educational content according to a first embodiment of the present application. Specifically, FIG. 3 is a flowchart of a method of recommending solution content according to the first embodiment of the present application. The method of recommending solution content according to the first embodiment of the present application includes acquiring search information of a user (S1100), acquiring question information (S1200), acquiring a solution content set related to the question information (S1300), calculating learning ability information of a user (S1400), calculating an index for an expected educational effect (S1500), and selecting target solution content (S1600). In the acquiring of the search information of the user (S1100), the device 1000 for recommending educational content may acquire the search information of the user received from the user terminal 100.

In the acquiring of the question information (S1200), the device 1000 for recommending educational content may acquire question information indicating the question that the user has searched for from the search information. Here, the question information may mean encompassing any information that may identify the question searched by the user.

In the acquiring of the solution content set related to the question information (S1300), the device 1000 for recommending educational content may acquire the solution content set corresponding to the question information from the database based on the question information. The solution content set may include a plurality of pieces of solution content including the first solution content and the second solution content. In this case, the solution content expected to increase the educational effect for each user may be different. Therefore, the device 1000 for recommending educational content according to the embodiment of the present application may quantify the expected educational effect for each piece of solution content and compare the quantified indexs to select the target solution content, thereby providing the optimal solution content to the user. In this case, the device 1000 for recommending educational content may use the learning ability information of the user to select the target solution content.

In the calculating of the learning ability information of the user (S1400), the device 1000 for recommending educational content may calculate the learning ability information of the user based on the search information of the user. More specifically, in the calculating of the learning ability information of the user (S1400), the device 1000 for recommending educational content may acquire a question set, which is a set of related questions, based on the search information of the user. In addition, the device 1000 for recommending educational content may quantify the learning ability information of the user based on the question set and the search information. For example, the device 1000 for recommending educational content may allocate a first feature value to a question searched by a user among questions included in the question set and allocate a second feature value different from the first feature value to a question that the user has not searched for among questions included in the question set. In this case, the device 1000 for recommending educational content may be implemented to calculate the learning ability information of the user based on the generated matrix.

The operation of calculating the learning ability information of the user will be described in detail below with reference to FIGS. 8 to 14.

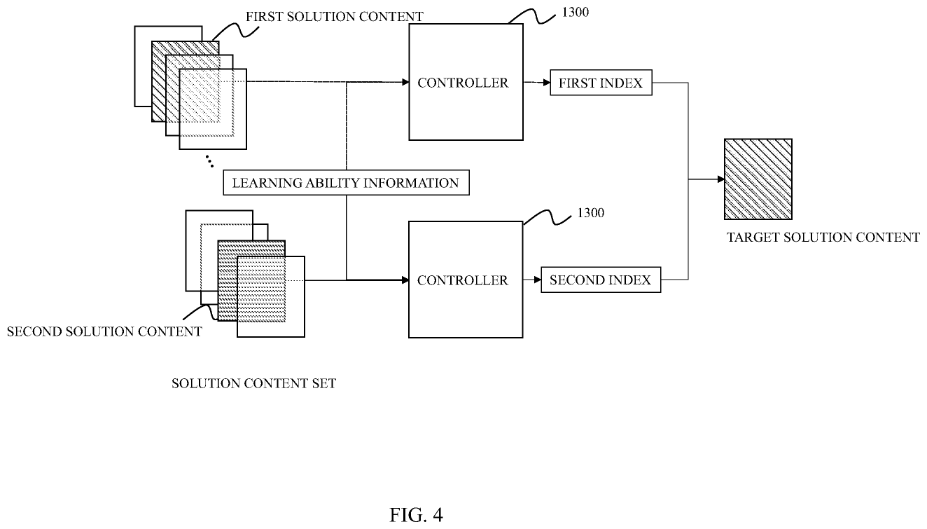

FIG. 4 is an exemplary diagram illustrating an aspect in which the device 1000 for recommending educational content selects the target solution content according to the first embodiment of the present application.

In the selecting of the target solution content (S1600), the device 1000 for recommending educational content may select the target solution content based on the index for the expected educational effect. Specifically, the device 1000 for recommending educational content may select the solution content with the greatest educational effect predicted for the user among the solution content set as the target solution content. For example, referring back to FIG. 4, when the expected educational effect when the first solution content is provided to the user is calculated as the first index, and the expected educational effect when the second solution content is provided to the user is calculated as the second index, the device 1000 for recommending educational content may be implemented to select the target solution content by comparing the first index and the second index. In particular, when the first index is calculated to be greater than the second index, the device 1000 for recommending educational content may be implemented to select the first solution content as the target solution content.

As an example, the device 1000 for recommending educational content may be configured to predict the learning ability of the user after the solution content is provided to the user and the user consumes the solution content, and select the target solution content based on the predicted learning ability of the user. For example, the device 1000 for recommending educational content may be configured to predict the probability of user reaction (for example, clicking on some content, etc.) when the solution content is provided to the user and calculate a prediction value of the learning ability of the user based on each reaction. In this case, the device 1000 for recommending educational content may be implemented to select the solution content representing the greatest expected value among the solution content set as the target solution content based on the probability and the predicted value.

However, the method of selecting target solution content described above is only an example, and the device 1000 for recommending educational content may be configured to select the target solution content based on the training data (for example, information related to the solution history) of the user. For example, the solution content similar to the solution history of the user may be selected as the target solution content, or the solution content different from the solution history of the user may be selected as the target solution content.

According to the first embodiment of the present application, since the solution content having the greatest expected educational effect of the user among a plurality of pieces of solution content may be implemented as the target solution content, the solution content most helpful for improving skills is provided to the user.

Hereinafter, an operation of the device 1000 for recommending educational content for selecting a target webpage based on search information of a user according to a second embodiment of the present application will be described in detail with reference to FIGS. 5 to 7. Hereinafter, content added or changed in the first embodiment will be mainly described. Also, hereinafter, the content overlapping with the content described in the first embodiment may be omitted, and the content described in the first embodiment may be applied.

The device 1000 for recommending educational content according to the second embodiment of the present application may perform an operation of recommending solution content based on the search information of the user.

Conventionally, a webpage is recommended by calculating a score for each page according to the number of links included in the page based on the search of the user. According to the related art, a webpage including content having the highest reliability among a plurality of pages related to a search is provided to a user. However, according to the related art, a webpage having high reliability may not affect an educational effect on the user. In particular, the related art may be suitable for selecting a webpage related to a search from various webpage including various types of content. However, in the related art, there are limitations in selecting content that maximizes the educational effect in educational content that has already secured reliability. Therefore, there is a need for research on a technology related to a search engine that selects a webpage that may provide the greatest educational effect in consideration of the knowledge level information (or learning ability information) of the user. Hereinafter, the knowledge level information and the learning ability information will be interchangeably used and described. However, this is only for convenience of description and is not limitedly interpreted according to the difference in terms.

The device 1000 for recommending educational content according to the second embodiment of the present application calculates the learning ability information of the user based on the search information of the user and selects the target solution content based on the learning ability information of the user so that users may be provided with a webpage that may be most relevant to the search information of the user and maximize the educational effect on the user.

Hereinafter, with reference to FIG. 5, the operation of the device 1000 for recommending educational content according to the second embodiment of the present application for achieving the above-described object and effect will be described in detail. FIG. 5 is a diagram illustrating an operation of a device 1000 for recommending educational content according to a second embodiment of the present application.

The device 1000 for recommending educational content according to the present embodiment may acquire the search information of the user. Here, the search information may include a search query of a user, any type of information derived from the search query, and/or log data related to the search of the user, and question identification information related to the search. For example, the device 1000 for recommending educational content may acquire a search query of a user and acquire search information through an operation of extracting a keyword from the acquired search query or a natural language processing operation. In this case, the device 1000 for recommending educational content may calculate the learning ability information of the user based on the search information or select a candidate webpage set from a database.

Although not illustrated in FIG. 5, the device 1000 for recommending educational content according to the present embodiment may acquire response information and/or correct or incorrect answer information for a question related to a question solution history of a user.

The device 1000 for recommending educational content according to the present embodiment may perform an operation of evaluating the learning ability of the user or quantifying the learning ability. Specifically, the device 1000 for recommending educational content may quantify the learning ability of the user based on the search information of the user to calculate the learning ability information of the user (or knowledge level information, hereinafter described in terms of learning ability information). The operation of calculating the learning ability information of the user will be described in detail below with reference to FIGS. 8 to 14.

The device 1000 for recommending educational content according to the present embodiment may acquire a candidate webpage set from a database. Specifically, the device 1000 for recommending educational content may be implemented to acquire, from a database, at least one webpage set that are related to the search information of the user based on the search information of the user.

The device 1000 for recommending educational content according to the present embodiment can estimate or quantify the expected educational effect when each webpage included in the candidate webpage set is provided to the user. Specifically, the device 1000 for recommending educational content may estimate or quantify the expected educational effect when each webpage included in the candidate webpage set is provided to the user based on the learning ability information of the user. In this case, the device 1000 for recommending educational content may use user information (for example, learning ability information of a user), and content and/or search information included in the webpage to quantify the expected educational effect of the webpage. For example, the device 1000 for recommending educational content may calculate the first index related to the expected educational effect when the first webpage included in the candidate webpage set is provided to the user based on the learning ability information of the user. In addition, the device 1000 for recommending educational content may calculate the second index related to the expected educational effect when the second webpage included in the candidate webpage set is provided to the user based on the learning ability information of the user.

The device 1000 for recommending educational content according to the present embodiment may select a webpage having the greatest educational effect predicted from among a candidate webpage set as a target webpage. For example, when the expected educational effect when the first solution content is provided to the user is calculated as the first index, and the expected educational effect when the second solution content is provided to the user is calculated as the second index, the device 1000 for recommending educational content may be implemented to determine a target webpage by comparing the first index and the second index. For example, when the first index is calculated to be greater than the second index, the device 1000 for recommending educational content may be implemented to select the first webpage as the target webpage.

The device 1000 for recommending educational content according to the present embodiment may transmit the selected target webpage to the user terminal 100. Specifically, the device 1000 for recommending educational content may transmit the selected target solution content to the user terminal 100 through the transceiver 1100.

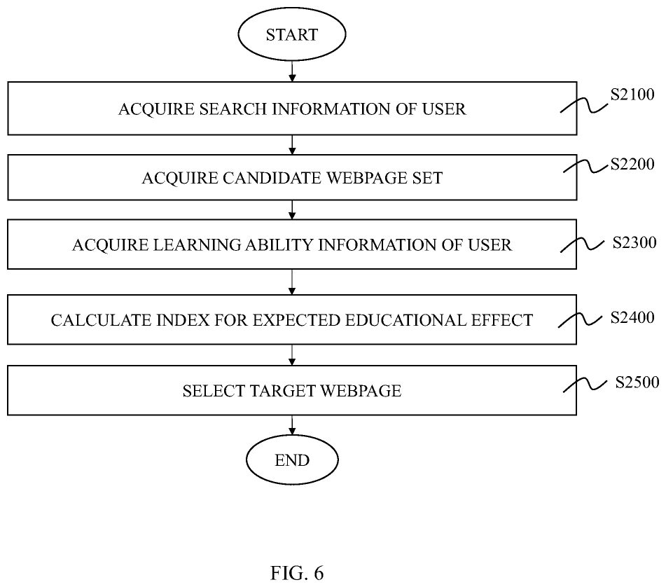

FIG. 6 is a flowchart of a method for recommending educational content according to a second embodiment of the present application. Specifically, FIG. 6 is a flowchart of a method of recommending a webpage according to the second embodiment of the present application. The method of recommending a webpage according to the second embodiment of the present application may include acquiring search information of a user (S2100), acquiring a candidate webpage set (S2200), calculating learning ability information of a user (S2300), calculating an index for the expected educational effect (S2400), and selecting a target webpage (S2500).

In the acquiring of the search information of the user (S2100), the device 1000 for recommending educational content may acquire the search information of the user received from the user terminal 100. Specifically, the device 1000 for recommending educational content may extract a keyword from a search query of a user received from the user terminal 100 and acquire the search information of the user through a natural language processing process. However, this is only an example, and the user terminal 100 may extract a keyword from a search query and processes the keyword with a natural language to acquire search information and then transmits the search information to the device 1000 for recommending educational content so that the device 1000 for recommending educational content may be implemented to acquire the search information.

In the acquiring of the candidate webpage set (S2200), the device 1000 for recommending educational content may acquire the candidate webpage set from the database. In this case, the candidate webpage set may include at least one webpage including the first webpage and the second webpage. Specifically, the device 1000 for recommending educational content may acquire the candidate webpage set from the database based on the search information of the user. As an example, the device 1000 for recommending educational content may select webpage that are related to the search information of the user and acquire the selected webpage as a candidate webpage set. For example, the device 1000 for recommending educational content may be implemented to acquire, as a candidate webpage set, a webpage including content in which information related to a keyword of search information of a user exists.

In the calculating of the learning ability information of the user (S2300), the device 1000 for recommending educational content may calculate the learning ability information of the user based on the search information of the user. The operation of calculating the learning ability information of the user will be described in detail below with reference to FIGS. 8 to 14.

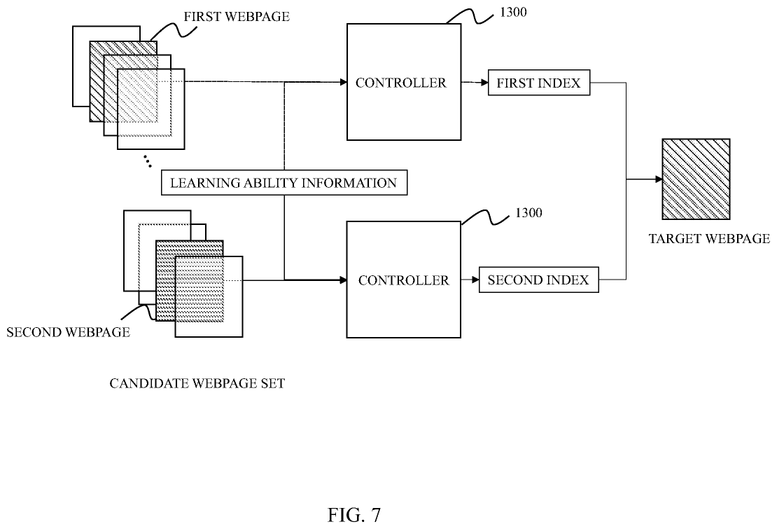

FIG. 7 is an exemplary diagram illustrating an aspect in which the device 1000 for recommending educational content selects a target webpage according to the second embodiment of the present application.

In the selecting of the target webpage (S2500), the device 1000 for recommending educational content may select the target webpage based on the index for the expected educational effect. Specifically, the device 1000 for recommending educational content may select a webpage with the highest educational effect predicted to the user among the candidate webpage set as the target webpage. For example, referring back to FIG. 7, when the expected educational effect when the first webpage is provided to the user is calculated as the first index, and the expected educational effect when the second webpage is provided to the user is calculated as the second index, the device 1000 for recommending educational content may be implemented to select a target webpage by comparing the first index and the second index. In particular, when the first index is calculated to be greater than the second index, the device 1000 for recommending educational content may be implemented to select the first webpage as the target webpage.

As an example, the device 1000 for recommending educational content may be configured to predict the learning ability of the user (or knowledge level) after the webpage included in the candidate webpage set is provided to the user and the user consumes the webpage, and select the target webpage based on the predicted learning skill of the user. For example, the device 1000 for recommending educational content may be configured to predict the probabilities of user reaction (for example, clicking on some content, etc.) when the webpage is provided to the user, and calculate a prediction value of the learning ability of the user based on each reaction. In this case, the device 1000 for recommending educational content may be implemented to select a webpage representing the greatest expected value among a candidate webpage set as a target webpage based on the probability and the predicted value.

According to the second embodiment of the present application, it may be implemented such that a webpage including content having the greatest expected educational effect of the user from among a plurality of webpage is selected as the target webpage. Accordingly, there is an advantageous effect that the webpage most helpful to the improvement in the skill of the user may be provided to the user.

Hereinafter, a method of calculating learning ability information of a user that may be commonly applied to operation S1400 of the first embodiment and operation 2300 of the second embodiment will be described in detail with reference to FIGS. 8 to 14. Hereinafter, the device 1000 for recommending educational content will be referred to as a device 2000 for evaluating learning ability in the sense that the learning ability of the user is evaluated. However, this is only for convenience of description and is not limitedly interpreted.

FIG. 8 is a flowchart illustrating a method of calculating learning ability information of a user according to an embodiment of the present application. The method of calculating learning ability information of a user includes acquiring search information of a target user (S3100), acquiring learning set information based on the search information (S3200), acquiring a search database of a plurality of users (S3300), allocating a feature value based on the search information (S3400), generating a first matrix (S3500), transforming the first matrix to generate a second matrix (S3600), and calculating a learning ability score of the target user (S3700).

In the acquiring of the search information of the target user (S3100), the device 200 for evaluating learning ability evaluation may acquire the search information of the target user received from the user terminal 100. Alternatively, the device 2000 for evaluating learning ability may acquire the search information of the target user from data received from the user terminal 100. As described above, the search information may refer to encompassing log data related to a search of a user, search-related question identification information, a search query, and any type of information derived from the search query. In addition, the log data may include time data for querying a specific question by a target user and time data for reading a search result.

In the acquiring of the learning set information based on the search information (S3200), the device 2000 for evaluating learning ability may acquire learning set information based on the search information. Specifically, the device 2000 for evaluating learning ability may acquire the learning set information based on the log data and the question identification information. For example, the device 2000 for evaluating learning ability may acquire information on a question on which a search is performed for a first predetermined period based on the time data of the log data and the question identification information. Here, it is highly likely that questions on which the search is performed for the first period are questions with high correlation with each other. In particular, it may be highly likely to be a common learning set. Accordingly, the device 2000 for evaluating learning ability may acquire the learning set information based on the question information searched for the first period.

Meanwhile, although not illustrated in FIG. 8, the device 2000 for evaluating learning ability according to the embodiment of the present application may predict whether the target user understands a question based on the search information. For example, based on the log data of the search information, it may be predicted whether the target user understands the searched question. Specifically, when the reading time data during which the target user reads the search result is less than the predetermined time, the probability that the target user understands the searched question may be high. On the other hand, when the reading time data at which the target user reads the search result is greater than the predetermined time, it is highly likely that the target user may not understand the searched question. Therefore, the device 2000 for evaluating learning ability according to the embodiment of the present application may predict or quantify the degree of understanding of questions by the target user based on the log data.

In addition, the device 2000 for evaluating learning ability according to the embodiment of the present application may determine a relationship between questions based on the search information. For example, the device 2000 for evaluating learning ability may acquire search time information for each question from the log data. The device 2000 for evaluating learning ability may be configured to identify a relationship between questions based on the search time information for each question. For example, as described above, questions for which a search was performed for the first predetermined period may be highly likely to configure a common learning set. The device 2000 for evaluating learning ability may acquire questions searched for the first predetermined period as the learning set information. Also, when a rate at which the first question is searched and the second question is searched is higher than a rate at which the second question is searched and the first question is searched, it may be highly likely that the first question should be trained before the second question. Therefore, the device 2000 for evaluating learning ability according to the embodiment of the present application may calculate information related to which of the first and second questions is a prior learning question based on the log data of search information.

In the acquiring of the search database (S3300), the device 2000 for evaluating learning ability may acquire the search database of a plurality of users based on the learning set information. Specifically, the search database may be acquired based on question information included in the learning set information. For example, when the first question is included in the learning set information, the device 2000 for evaluating learning ability may acquire a search database including search information of a plurality of users for the first question based on the identification information of the first question. Here, the search database may include identification information of each of the plurality of users. In addition, the search database may include information on a reference value allocated according to whether the question included in the learning set information is searched based on the search information of each of the plurality of users. For example, when the first user has a history of performing a search for the first question included in the learning set information, the search database may include the identification information for the first question and the information on the reference value for which the first value is allocated to the first question. As another example, when the first user does not perform a search for the second question included in the learning set information, the search database may include the identification information for the second question and the information on the reference value for which the second value is allocated to the second question. Meanwhile, when the second user does not perform a search for the first question included in the learning set information, the search database may include the identification information for the first question and the information on the reference value for which the second value is allocated to the first question. As another example, when the second user performs a search for the second question included in the learning set information, the search database may include the identification information for the second question and the information on the reference value for which the second value is allocated to the second question. In this case, the first value and the second value may be different. In other words, the search database may include the user identification information and the information on the reference value allocated according to whether the user searches for the question included in the learning set information.

Additionally, there may be cases in which it is not confirmed whether to search for the question included in the learning set information. In this case, the search database may allocate a third value different from the first value and the second value as a reference value to the questions of the learning set information for which search or not is not confirmed.

In the allocating of the feature value based on the search information (S3400), the device 2000 for evaluating learning ability may allocate the feature value according to whether the target user searches for each question included in the learning set information based on the search information of the target user.

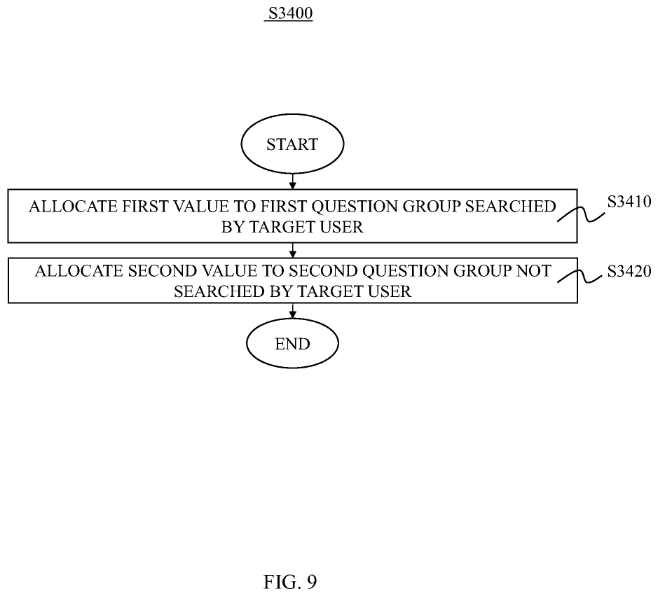

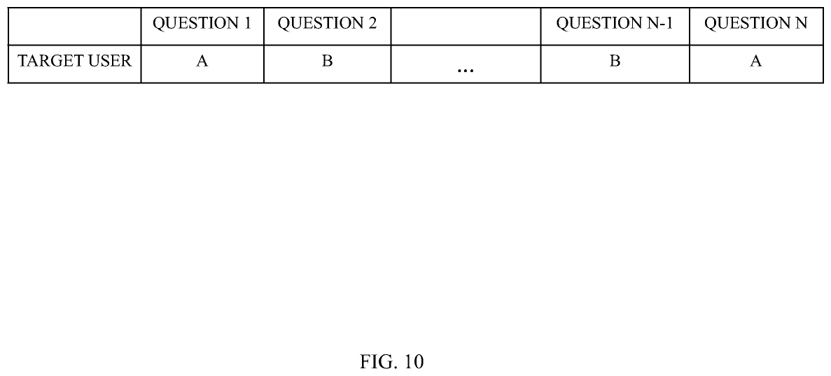

See FIGS. 9 and 10. FIG. 9 is a detailed flowchart of an operation (S3400) of allocating a feature value based on search information according to an embodiment of the present application. FIG. 10 is a diagram illustrating an aspect of allocating a feature value based on the search information according to the embodiment of the present application.

The allocating of the feature value based on the search information (S3400) includes allocating the first value to the first question group searched by the target user (S3410) and allocating the second value to the second question group not searched by the target user (S3420).

In the allocating of the first value to the first question group searched by the target user (S3410), the device 2000 for evaluating learning ability may allocate the feature value (A in FIG. 10) as the first value to the first question group searched by the target user among the questions included in the learning set information based on the search information of the target user. Specifically, it is assumed that the target user performs a search for the first question group including a first question and an N^{th} question among the questions included in the learning set information. In this case, the device 2000 for evaluating learning ability may recognize the information that the target user performed a search for the first question group including the first question and the N^{th} question from the search information of the target user and may allocate the feature value as the first value to each of the questions belonging to the first question group including the first question and the N^{th} question.

In the allocating of the second value to the second question group not searched by the target user (S3410), the device 2000 for evaluating learning ability may allocate the second value (B in FIG. 10) to the second question group not searched by the target user among the questions included in the learning set information based on the search information of the target user. Specifically, it is assumed that the target user does not perform a search for the second question group including a second question and an (N−1)^{th} question among the questions included in the learning set information. In this case, the device 2000 for evaluating learning ability may recognize the information that the target user does not perform a search for the second question group including the second question and the (N−1)^{th} question from the search information of the target user and may allocate the feature value as the second value to each of the questions belonging to the second question group including the second question and the (N−1)^{th} question.

In the generating of the first matrix (S3500), the device 2000 for evaluating learning ability may generate the first matrix based on the reference value of the search database and the feature value related to the target user. Specifically, the device 2000 for evaluating learning ability may generate the first matrix based on the feature values allocated according to whether the target user searches for the questions included in the learning set information and the reference value allocated according to whether the plurality of users search for questions included in the learning set information.

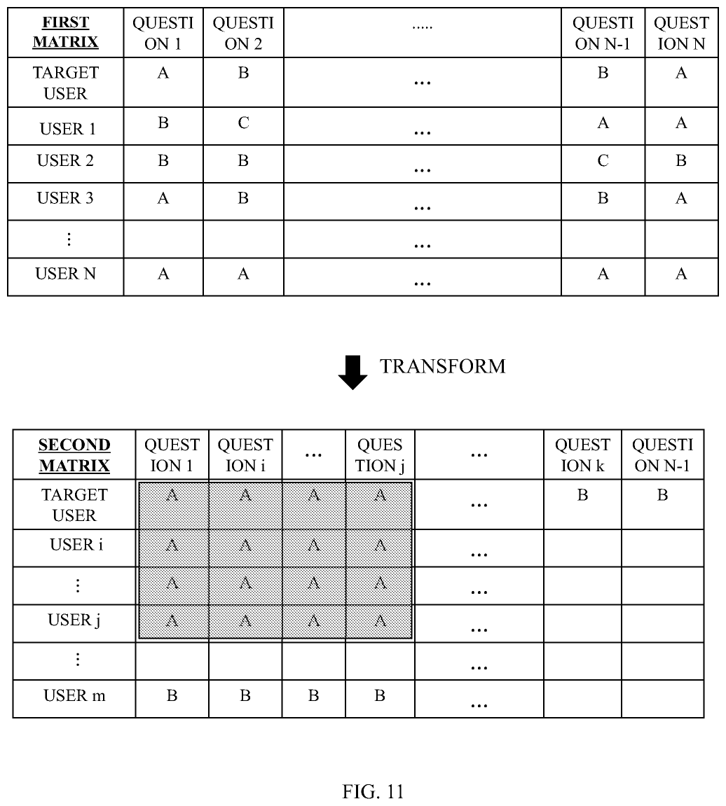

See FIG. 11. FIG. 11 is a diagram illustrating an aspect of a first matrix and a second matrix generated according to the present embodiment. For example, the first matrix generated based on the feature value of the target user and the reference value of the search database may be a matrix that has user identification information as rows (or columns), question identification information as columns (or rows), and has feature values and reference values as components.

In the generating of the second matrix by transforming the first matrix (S3600), the device 2000 for evaluating learning ability may acquire the second matrix by transforming the first matrix. For example, the device 2000 for evaluating learning ability may convert values of the first matrix using a block compressing technique. When the block compressing technique is used, the first matrix may be transformed into the second matrix based on the similarity between the reference value and the feature value included in the first matrix. More specifically, when the block compressing technique is used, the same components of the reference value and the feature value included in the first matrix may be clustered.

For example, referring back to FIG. 11, the second matrix may be generated by transforming the first matrix, and in this case, the components related to the reference value having the same component as the component of the target user may be clustered in the second matrix. More specifically, the components having the reference value having the same first value as the target user may be clustered in the second matrix for the questions of the component whose feature value has the first value (for example, A).

In the calculating of the learning ability score of the target user (S3700), the device 2000 for evaluating learning ability may calculate the learning ability score of the target user based on the second matrix. Specifically, the second matrix includes information on whether a target user and a plurality of users search for questions included in the learning set information. For example, the fact that the user searches for a question is highly likely to mean that the user is completely unaware of the searched question. On the other hand, the fact that the user did not search for the question may mean that there is a high probability that the user knows about the question. Therefore, the device 2000 for evaluating learning ability according to the present embodiment may quantify the learning ability information of the target user by calculating the learning ability score of the target user based on the second matrix.

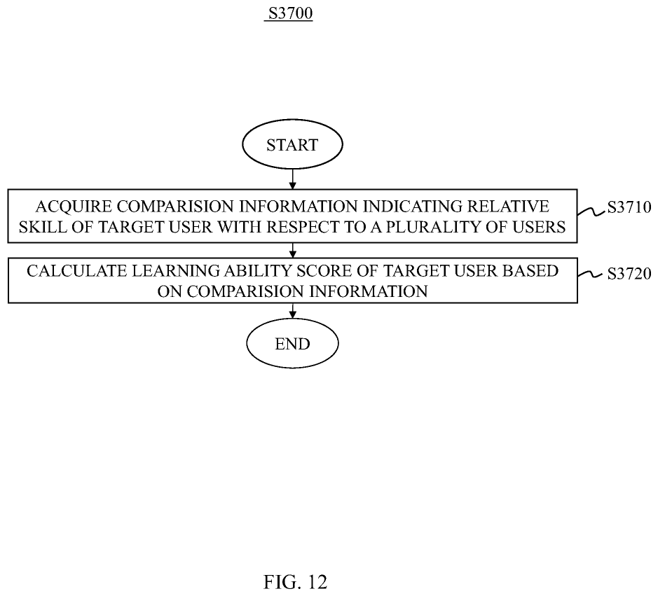

Hereinafter, a method of calculating a learning ability score of a target user by the device 2000 for evaluating learning ability according to the present embodiment will be described in detail with reference to FIGS. 12 to 14.

FIG. 12 is a detailed flowchart of a method of calculating a learning ability score of a target user according to an embodiment of the present application. The calculating of the learning ability score of the target user according to the present embodiment may include acquiring comparison information indicating the relative skill of the target user with respect to a plurality of users (S3710) and calculating the learning ability score of the target user based on the comparison information (S3720).

In the acquiring of the comparison information indicating the relative skill of the target user with respect to the plurality of users (S3710), the device 2000 for evaluating learning ability may acquire the comparison information based on the second matrix. For example, the device 2000 for evaluating learning ability may acquire comparison information through a trained neural network model.

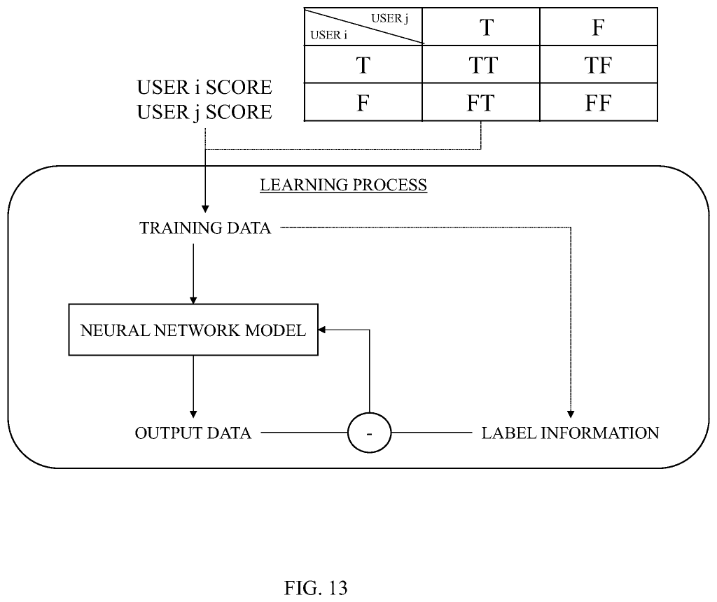

FIG. 13 is a diagram illustrating an aspect of training a neural network model to acquire comparison information according to an embodiment of the present application.

According to the present embodiment, the method of calculating a learning ability score of a target user may use a neural network model. Specifically, the neural network model may be provided as a machine learning model. As a representative example of the machine learning model, there may be an artificial neural network. Specifically, a representative example of the artificial neural network is a deep learning-based artificial neural network that includes an input layer that receives data, an output layer that outputs a result, and a hidden layer that processes data between the input and output layers. Specific examples of the artificial neural network include a convolution neural network, a recurrent neural network, a deep neural network, a generative adversarial network, and the like. In the present specification, the neural network should be interpreted in a comprehensive sense including all of the artificial neural networks described above, other various types of artificial neural networks, and artificial neural networks in a combination thereof, and does not necessarily have to be a deep learning series.

In addition, the machine learning model does not necessarily have to be in the form of the artificial neural network model, and in addition, there may be k-nearest neighbor algorithm (KNN), random forest, support vector machine (SVM), principal component analysis (PCA), etc. Alternatively, the above-described techniques may include an ensemble form or a form in which various other methods are combined. On the other hand, it is stated in advance that the artificial neural network can be replaced with another machine learning model unless otherwise specified in the embodiments mainly described with the artificial neural network.

Furthermore, in the present specification, an algorithm for acquiring comparison information of a target user is not necessarily limited to a machine learning model. That is, the algorithm for obtaining the comparison information of the target user may include various judgment/determination algorithms other than the machine learning model. Therefore, in the present specification, it is disclosed that the algorithm for acquiring the comparison information of the target user should be understood as a comprehensive meaning including all types of algorithms for acquiring comparison information using the input data of the target user.

Referring back to FIG. 13, the neural network model for acquiring the comparison information of the target user according to the present embodiment may be configured to receive training data and output the data.

Here, the training data may include score information of any users (for example, user i, user j). Specifically, the score information of any users may be information on an education system different from the education system of the learning ability information of the target user to be calculated. For example, the learning ability score of the target user to be calculated may be information related to the first education system (for example, scholastic aptitude test (SAT)). On the other hand, the training data used to train the neural network model may be information related to a second education system (for example, test of English for international communication (TOEIC)) different from the first educational system (for example, SAT). According to the present embodiment, it is possible to acquire the learning ability information of the target user for the second education system based on the training data of the users for the first education system. In particular, even when there is only the search information of the target user for the second education system, the learning ability information of the target user in the second education system may be calculated based on the training data of the user for the first education system.

In addition, the training data may include response information and/or correct or incorrect answer information of any users (for example, user i, user j). Specifically, the training data may include response comparison information between any users. The response comparison information may include information related to the number of questions (TT) solved by both user i and user j, the number of questions (TF) solved only by user i, the number of questions (FT) solved only by user j, and the number of questions (FF) for which both user i and user j answered incorrectly. However, the response comparison information may include response comparison information for questions having similarity within a preset range as well as response comparison information for the completely identical question. For example, when the user i solved the first question and the user j solved the second question, but it is determined that the first question and the second question have similarity within a preset range and are similar in difficulty or type, this may be regarded as solving the same question and reflected in the response comparison information.

The neural network model according to the present embodiment is configured to receive training data through an input layer and output the data through an output layer. In this case, the neural network model may be trained by repeatedly performing an operation of adjusting parameters of at least one node included in the neural network model so that output data and label information are minimized. Here, the label information may be information indicating the relative skill between users. As an example, the label information indicating the relative skill of the user i may be information related to the number of questions (TT) that both user i and user j answered correctly/(the number of questions (TT) that both user i and user j answered correctly+the number of questions (FT) that only user j answered correctly). For example, suppose that the number of questions that both the user i and user j answered correctly is 90, the number of questions that only the user i answered correctly is 10, the number of questions that only the user j answered correctly is 110, and the number of questions that both the user i and user j answered incorrectly is 40. Here, it can be seen that the user i correctly answered 45% ({(90/(90+110)}*100) of 200 questions that the user j answered correctly, and the user j correctly answered 90% ((90/(90+10)}*100) of 100 questions that the user i answered correctly. That is, it may mean that the knowledge of the user j includes the knowledge of the user i, and as a result, through the label information, relative skill information indicating that user j has a relatively higher skill than user i may be acquired.

Through the above-described learning process, the neural network model may be trained so that the output data output through the output layer approaches the label information based on the training data.

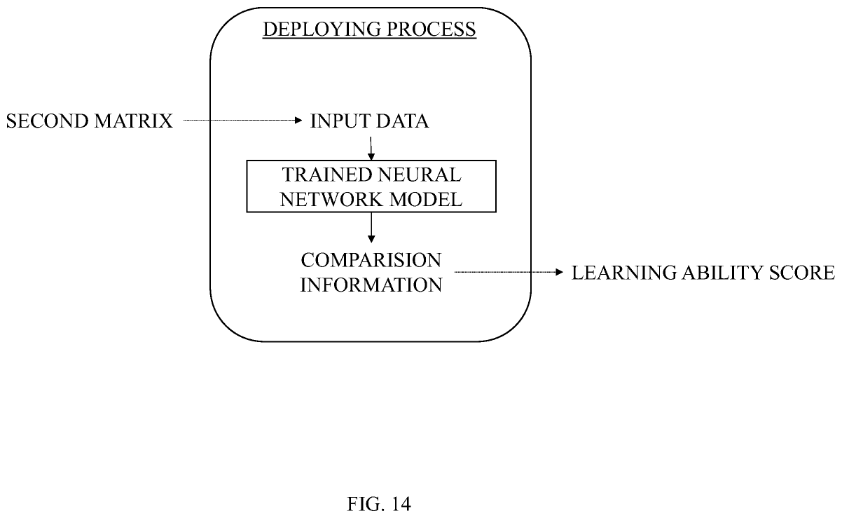

FIG. 14 is a diagram illustrating an aspect of acquiring comparison information and a learning ability score of a target user through a neural network model trained according to an embodiment of the present application. The device 2000 for evaluating learning ability may acquire input data from the second matrix. Here, the input data may be in a form similar to the response comparison information between the target user and any users described above with reference to FIG. 13. In more detail, the input data may be acquired based on the search information of the target user and search information of a search database. As described above, the target user (or a plurality of users) is highly likely to be unaware of the question (for example, a question with A allocated as a feature value) retrieved among the questions included in the learning set information, so input data may be acquired by corresponding to the number of questions answered incorrectly in the response comparison information. On the other hand, the target user (or a plurality of users) is highly likely to be aware of the question (for example, a question with B allocated as a feature value) not searched among the questions included in the learning set information, and thus input data may be acquired by corresponding to the number of questions answered correctly in the response comparison information.

Meanwhile, the plurality of users included in the input data may be users with questions overlapping with the target user relatively a lot. For example, the plurality of users included in the input data may be at least one of a target user and a clustered user on the second matrix.

The device 2000 for evaluating learning ability may input data into a trained neural network model and acquire comparison information output through the trained neural network model. Since the neural network model has been trained to output a value close to the label information through the output layer, the trained neural network model may output the comparison information related to the relative ability of the target user with respect to a plurality of users. Therefore, the device 2000 for evaluating learning ability according to the present embodiment may acquire the comparison information through the trained neural network model. In addition, since the comparison information is an index of the relative learning ability of the target user and any user, the device 2000 for evaluating learning ability acquires the comparison information between the target user and at least one user to quantify the relative skill of the target user with the learning ability score.

In the calculating of the learning ability score of the target user based on the comparison information (S3720), the device 2000 for evaluating learning ability may calculate the learning ability score of the target user based on the comparison information acquired through the trained neural network model. Here, the learning ability score of the target user may mean encompassing any type of numerical value that may represent the relative ability of the target user with respect to a plurality of users, including scores or the like related to official tests.

On the other hand, in FIGS. 12 to 14, the contents of training the neural network model to output the comparison information based on the training data were mainly described. However, this is only an example, and the second neural network model may be trained to output the learning ability score of the target user. For example, the second neural network model may receive a user j score and response comparison information, and use a user i score as label information so that the output data may be trained to approximate the label information. In this case, the device 2000 for evaluating learning ability may be implemented to acquire the learning ability score of the target user through the trained second neural network model.

The device 1000 for recommending educational content (or device 2000 for evaluating learning ability) according to the embodiment of the present application may quantify the learning ability information of the user based on the search information of the user. In particular, an advantageous effect that the relative learning ability information of the user may be calculated using only the search information of the user may be provided.

In addition, the device 1000 for recommending educational content (or device 2000 for evaluating learning ability) according to the embodiment of the present application may provide a user with educational content (for example, webpage, solution information) that maximizes the expected educational effect for the user based on the search information of the user.

Various operations of the device 1000 for recommending educational content (or device 2000 for evaluating learning ability) described above may be stored in a memory 12000 of the device 1000 for recommending educational content, and a controller 1300 of the device 1000 for recommending educational content may be provided to perform the operations stored in the memory 1200.

Features, structures, effects, etc., described in the above embodiments are included in at least one embodiment of the present invention and are not necessarily limited only to one embodiment. Furthermore, features, structures, effects, etc., illustrated in each embodiment can be practiced by being combined or modified for other embodiments by those of ordinary skill in the art to which the embodiments pertain. Accordingly, the content related to such combinations and modifications should be interpreted as being included in the scope of the present invention.

According to a method, device, and system for recommending educational content to an embodiment of the present application, it is possible to quantify learning ability information of a user based on search information of a user.

According to a method, device, and system for recommending educational content to an embodiment of the present application, by selecting educational content in consideration of learning ability of a user, it is possible to provide a user with educational content that is most helpful for the improvement in the skill of the user.

Effects of the present invention are not limited to the above-described effects, and effects that are not described will be clearly understood by those skilled in the art to which the present invention pertains from the present specification and the accompanying drawings.

In addition, although the embodiments have been mainly described hereinabove, this is only an example and does not limit the present invention. Those skilled in the art to which the present invention pertains may understand that several modifications and applications that are not described in the present specification may be made without departing from the spirit of the present invention. That is, each component specifically shown in the embodiment may be implemented by modification. In addition, differences associated with these modifications and applications are to be interpreted as being included in the scope of the present invention as defined by the following claims.

What is claimed is:

1. A method of recommending educational content by a device for analyzing search information of a user, the method comprising:
acquiring the search information of the user;
extracting searched question information based on the search information;
acquiring a solution content set related to the question information, the solution content set including first solution information and second solution information;
calculating learning ability information of the user based on the search information;
calculating an index related to an expected educational effect based on the learning ability information and the solution content set;
selecting target solution content from the solution content set based on the index; and
transmitting the target solution content.

2. The method of claim 1, wherein the search information includes log data including searched time data and reading time data of a search result.

3. The method of claim 2, wherein the calculating of the learning ability information includes:
acquiring learning set information based on the log data and the question information; and
calculating the learning ability information according to whether to search for questions included in the learning set information.

4. The method of claim 3, wherein the acquiring of the learning set information includes:
acquiring question information on which a search is performed for a first period based on the time data of the log data and the question information; and
acquiring the learning set information based on the question information.

5. The method of claim 1, wherein the calculating of the index includes:
acquiring a first index related to an expected educational effect when the first solution information is provided to the user based on the learning ability information and the first solution information; and
acquiring a second index related to an expected educational effect when the second solution information is provided to the user based on the learning ability information and the second solution information.

6. The method of claim 5, wherein the selecting of the target solution content includes comparing the first index and the second index to determine that the solution information calculated with a greater value is the target solution content.

7. A non-transitory computer-readable recording medium in which a computer program executed by a computer is recorded, the computer program comprising:
acquiring the search information of the user;
extracting searched question information based on the search information;
acquiring a solution content set related to the question information, the solution content set including first solution information and second solution information;
calculating learning ability information of the user based on the search information;
calculating an index related to an expected educational effect based on the learning ability information and the solution content set;
selecting target solution content from the solution content set based on the index; and
transmitting the target solution content.

8. A device for recommending educational content by receiving search information of a user from an external user terminal, the device comprising:
a transceiver configured to communicate with the user terminal; and
a controller configured to acquire the search information of the user through the transceiver and select target solution content based on the search information,
wherein the controller is configured to acquire the search information of the user, extract searched question information based on the search information, acquire a solution content set related to the question information, the solution content set including first solution information and second solution information, calculate learning ability information of the user based on the search information, calculate an index related to an expected educational effect based on the learning ability information and the solution content set, select target solution content from the solution content set based on the index, and transmit the target solution content.

9. The device of claim 8, wherein the search information includes log data including searched time data and reading time data of a search result.

10. The device of claim 9, wherein the controller is configured to acquire learning set information based on the log data and the question information and calculate the learning ability information according to whether to search for questions included in the learning set information.

11. The device of claim 10, wherein the controller is configured to acquire question information, on which a search is performed for a first period based on the time data of the log data and the question information, and acquire the learning set information based on the question information.

12. The device of claim 8, wherein the controller is configured to acquire a first index related to an expected educational effect when the first solution information is provided to the user based on the learning ability information and the first solution information, and acquire a second index related to an expected educational effect when the second solution information is provided to the user based on the learning ability information and the second solution information.

13. The device of claim 12, wherein the controller is configured to compare the first index and the second index to determine that the solution information calculated with a greater value is the target solution content.
